(19) United States
(12) Patent Application Publication
(10) Pub. No.: US 2022/0088557 A1
(43) Pub. Date: Mar. 24, 2022

(54) DIALCOHOL CELLULOSE-BASED SPHERICAL CAPSULES

(71) Applicant: NOURYON CHEMICALS INTERNATIONAL B.V., ARNHEM (NL)

(72) Inventors: Per LARSSON, Danderyd (NL); Katarzyna MYSTEK, Solna (NL); Lars WAGBERG, Stockholm (NL); Anna LARSSON-KRON, Sundsvall (NL); Bo ANDREASSON, Sundsvall (NL)

(73) Assignee: NOURYON CHEMICALS INTERNATIONAL B.V., ARNHEM (NL)

(21) Appl. No.: 17/310,174

(22) PCT Filed: Jan. 24, 2020
(86) PCT No.: PCT/EP2020/051837

§ 371 Date: Jul. 23, 2021

(30) Foreign Application Priority Data
Jan. 25, 2019 (EP) 19153646.5

(51) Int. Cl. B01J 13/14; C08L 1/02

(52) U.S. Cl. CPC B01J 13/14; C08L 1/02

(57) ABSTRACT

The present disclosure relates to spherical capsules comprising a polymeric shell surrounding a hollow core, in which the polymeric shell comprises an dialcohol cellulose that is optionally substituted. The present disclosure also relates to a process for preparing such spherical capsules, comprising mixing a solution comprising dissolved dialcohol cellulose that is optionally substituted and one or more non-polar organic compounds with an antisolvent, wherein the antisolvent comprises or consists of one or more compounds, and has a polarity less than that of water.

### CROSS-REFERENCE TO RELATED APPLICATION

This application is a U.S. National-Stage entry under 35 U.S.C. § 371 based on International Application No. PCT/EP2020/051837, filed Jan. 24, 2020 which was published under PCT Article 21(2) and which claims priority to European Application No. 19153646.5, filed Jan. 25, 2019, which are all hereby incorporated in their entirety by reference.

### TECHNICAL FIELD

The present disclosure relates to hollow spherical capsules made from cellulose-based biopolymers, and also to a process for their production.

### BACKGROUND

Thermally expandable microspheres are known in the art, and are described for example in U.S. Pat. No. 3,615,972, WO 00/37547 and WO2007/091960. A number of examples are sold under the trade name Expancel®. They can be expanded to form extremely low weight and low density fillers, and find use in applications such as foamed or low density resins, paints and coatings, cements, inks and crack fillers. Consumer products that often contain expandable microspheres include lightweight shoe soles (for example for running shoes), textured coverings such as wallpaper, solar reflective and insulating coatings, food packaging sealants, wine corks, artificial leather, foams for protective helmet liners, and automotive weather strips.

Thermally expandable polymer microspheres usually comprise a thermoplastic polymeric shell, with a hollow core comprising a blowing agent which expands on heating. Examples of blowing agents include low boiling hydrocarbons or halogenated hydrocarbons, which are liquid at room temperature, but which vapourise on heating. To produce expanded microspheres, the expandable microspheres are heated, such that the thermoplastic polymeric shell softens, and the blowing agent vapourises and expands, thus expanding the microsphere. Typically, the microsphere diameter can increase between 1.5 and 8 times during expansion.

A problem associated with the thermoplastic polymers typically used in the microspheres is that they are not derived from sustainable sources. Typical monomers include those based on acrylates, acrylonitriles, acrylamides, vinylidene dichloride and styrenes, which are mainly derived from petrochemical sources. In addition, many polymers are non-biodegradable, or at least biodegrade so slowly that they risk cumulative build-up in the environment.

Hollow polymeric spheres with larger dimensions, e.g. on the millimetre scale, can also be made. They have potential for use as drug delivery agents, for example, and hence their production using biologically sourced polymers would be desirable to help improve their compatibility and acceptance.

Cellulose spheres can be made, as described for example by Pettersson and Eriksson in Anal. Biochem., 2000, 285(2), 220-224. However, these are bead-like spheres, as opposed to hollow “core/shell” type capsules. They also tend to be inflexible and cannot be expanded once formed.

Therefore, there is a need for alternative biologically-sourced or biologically-derived polymers that can successfully form spherical capsules and/or microcapsules having a core-shell structure, including those which can be expanded post-synthesis.

### BRIEF SUMMARY

The present disclosure is directed to spherical capsules comprising a polymeric shell surrounding a hollow core, in which the polymeric shell comprises an dialcohol cellulose that is optionally substituted.

The present disclosure is also directed to a process for preparing such spherical capsules, comprising mixing a solution comprising dissolved dialcohol cellulose that is optionally substituted and one or more non-polar organic compounds with an antisolvent to form spherical capsules, wherein the antisolvent comprises or consists of one or more compounds and has one or more of the following features.

The antisolvent can have a calculated dielectric constant, εanti of less than about 80.1, according to the equation:

$${ɛ}_{a n t i} = {\sum }_{i = 1}^{n} {ɛ}_{i} {M}_{i}$$

where:
εanti=the calculated dielectric constant of the antisolvent at about 20° C.;
εi=the dielectric constant of pure compound i at about 20° C.;
n=the number of different compounds in the antisolvent;
Mi=the mole fraction of compound i in the antisolvent.

The antisolvent can have a calculated relative polarity, [E_{T}^{N}]ₐₙₜᵢ of less than about 1.00, calculated according to the equation:

$${[ {E}_{T}^{N} ]}_{a n t i} = {\sum }_{i = 1}^{n} {[ {E}_{T}^{N} ]}_{i} {M}_{i}$$

where:
[E_{T}^{N}]ₐₙₜᵢ=the calculated relative polarity of the antisolvent;
[E_{T}^{N}]ᵢ=the relative polarity of pure compound i at about 25° C. and atmospheric pressure, compared to water;
n=the number of different compounds in the antisolvent;
Mi=the mole fraction of compound i in the antisolvent.

The antisolvent can comprise or consist of one or more compounds selected from C1-6 alcohols, C2-6 diols, C3-6 triols, C1-6 haloalcohols, C1-6 halodialcohols, C1-6 alcoholethers, C1-6 glycol ethers or glycerol ethers, C1-6 ketones and diketones, C1-6 aldehydes, C1-8 haloethers, C1-6 amines, C1-6 alcoholamines, C1-6 carboxylic acids and also their anhydrides and C1-4 esters, C1-6 nitriles, C1-6 amides and their C1-2 alkyl N- or N,N-substituted derivatives, C4-8 cyclic anhydrides or amides, C1-6 organosulfates and C1-6 sulfoxides. In addition, the antisolvent can also comprise water.

The one or more non-polar organic compounds can have a solubility in the antisolvent of less than about 1 wt %.

In the discussion below, the terms “(substituted) dialcohol cellulose”, “dialcohol cellulose and/or substituted dialcohol cellulose” and “optionally substituted dialcohol cellulose” have the same meaning.

### BRIEF DESCRIPTION OF THE DRAWINGS

The present disclosure will hereinafter be described in conjunction with the following drawing figures, wherein like numerals denote like elements, and:

FIG. 1 is a collection of photographs (a)-(e) of spherical capsules made using C1-2 alcohols or mixtures of water and C1-2 alcohols as antisolvents

FIG. 2 includes two photographs (a) and (b) of wet and air-dried capsules of dialcohol cellulose;

FIG. 3 includes a series of electron micrographs (a)-(f) of freeze-dried wet dialcohol cellulose capsules and air-dried capsules;

FIG. 4 includes photographs (a) and (b) of pre- and post-expanded dialcohol cellulose capsules when suspended in water;

FIG. 5 includes photographs (a) and (b) of pre- and post-expanded wet dialcohol cellulose capsules;

FIG. 6 includes comparative photographs (a) and (b) of pre- and post-expanded wet capsules of dialcohol cellulose and cellulose.

### DETAILED DESCRIPTION

The following detailed description is merely exemplary in nature and is not intended to limit the present disclosure or the application and uses of the present disclosure. Furthermore, there is no intention to be bound by any theory presented in the preceding background of the present disclosure or the following detailed description.

In this disclosure, dialcohol cellulose refers to a form of modified cellulose, in which at least some of the glucose monomer rings have been opened. This is typically achieved by oxidation, which breaks the C2-C3 carbon-carbon bond to form two aldehyde groups, which are subsequently reduced to alcohol groups. The reaction can be represented by the Scheme (1) below:

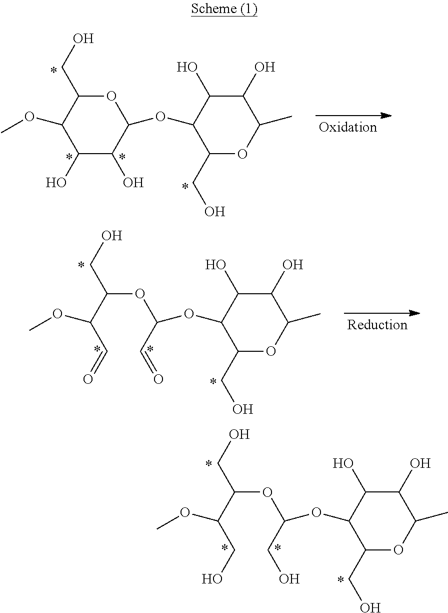

The formation of dialcohol cellulose from cellulose is well-known, and is described for example in Kasai et al; Cellulose, 2014, 21, 769-776, Larsson et al; Cellulose, 2014, 21, 323-333, and Larsson and Wågberg; Green Chem., 2016, 18, 3324-3333. The general procedure involves taking cellulose or methylol cellulose (i.e. a cellulose treated with formaldehyde and DMSO) and treating it with an oxidising agent, for example a periodate salt such as sodium periodate (NaIO4), to form a ring-opened dialdehyde compound. The aldehyde groups are then reduced to hydroxyl groups using a reducing agent such as a tetraborohydride salt (e.g. NaBH4). The so-reduced material is termed dialcohol cellulose.

The extent of ring opening can be varied, for example by varying the length of time that the cellulose is held in contact with the oxidizing agent, the temperature of treatment, and/or the relative ratio of cellulose to oxidant. In embodiments, the percentage of ring-opened glucose monomers in the cellulose (often termed the degree of oxidation) is up to about 100%, for example up to about 70%, such as up to about 50% or up to about 40%. In embodiments, it is at least about 1%, for example at least about 5%, or at least about 10%.

The extent of glucose ring-opening of the dialcohol cellulose can be determined by calculating the carbonyl content of the cellulose after the oxidation step, but before the reduction step. In embodiments, after the oxidation phase but before the reduction phase, the carbonyl content is in the range of from about 0.001 to about 12 mmol g-1, for example from about 1 to about 11, from about 3 to about 9 or from about 5 to about 8 mmol g-1. These values can be determined using known methods, such as the hydroxylamine hydrochloride-based methods described in Zhao and Heindel; Pharm Res 1991, 8(3), 400-402 and Larsson et al; Cellulose, 2008, 15, 837-847, and as described by Larsson et al, Cellulose, 2014, 21 on page 325.

The carbonyl content of the dialcohol cellulose after reduction is typically in the range of from about 0 to about 10 mmol g-1, for example in the range of from about 0 to about 7 mmol g-1 or from about 0 to about 4 mmol g-1. In embodiments, there is at least some carbonyl content, for example at least about 0.001 mmol g-1.

The extent of ring opening can also be correlated with a so-called crystallinity index of the cellulose. Unmodified cellulose has a crystalline structure. However, the ring opening introduces amorphous regions, which is believed to introduce improved ductility to the cellulose, making it more suitable for spherical capsule formation, particularly for expandable capsules.

The extent of crystallinity of the dialcohol cellulose can be determined by comparing the intensity of the cellulose (002) peak and the amorphous intensity, as shown for example in Larsson et al, Cellulose, 2014, 21, 323-333, in particular on page 327, based on Segal et al; Text. Res. J., 1959, 29(10), 786-794. The amorphous intensity can be measured from the minimum height between the (002) and (101) cellulose peaks.

In embodiments, the crystallinity index is about 80 or less, for example about 50 or less. In further embodiments, the crystallinity index is about 30 or less. In embodiments, there is at least some crystallinity, for example the crystallinity index is at least about 1 or at least about 10. Thus, exemplary ranges of crystallinity index include from about 0 to about 80, from about 0 to about 50 or from about 0 to about 30, for example from about 1 to about 80, from about 1 to about 50 or from about 1 to about 30. In further embodiments, the crystallinity index range is from about 10 to about 80, or from about 10 to about 50, such as from about 10 to about 30.

The capsules are based on a polymeric shell comprising or consisting of a dialcohol cellulose, which is optionally modified with one or more substituents as described further below.

The polymeric shell can include one or more additional polymeric components, which can also be selected from optionally substituted dialcohol celluloses, i.e., alcohol celluloses that are optionally substituted.

In embodiments, hydroxyl moieties on the dialcohol cellulose can be functionalised, for example by one or more functional groups. Thus, the dialcohol cellulose can comprise one or more functional groups represented by Formulae (1) to (3) below:

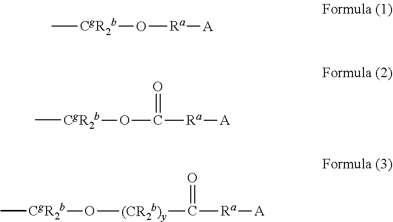

In other embodiments, the dialcohol cellulose can additionally or alternatively comprise aldehyde groups formed on oxidation of the cellulose, and/or functional groups based on reactions of such aldehyde groups. Thus, the dialcohol cellulose can additionally or alternatively comprise one or more groups according to formulae (4) to (7) below:

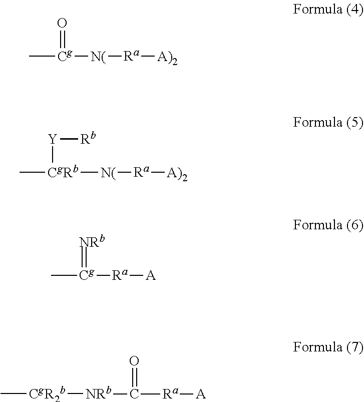

In the above formulae (1) to (7), Cg is a carbon atom that is part of the dialcohol cellulose backbone, i.e. any of the atoms marked by (*) in Scheme (1) above.

A can be selected from —H, —ORb, and —C(O)ORb. In embodiments, A is selected from —H and —C(O)OH.

In formula (5), Y is oxygen or is absent, i.e. a direct bond between Cg and Rb.

Ra can be selected from saturated or unsaturated aliphatic groups having from about 1 to about 11 carbon atoms, and which can be linear, branched or cyclic.

Ra can also be selected from about 5- and about 6-membered aromatic rings.

Ra can optionally comprise one or more substituents selected from —OH, halide, C1-4 alkyl, and C1-4 alkoxy, where the C1-4 alkyl and C1-4 alkoxy groups are optionally substituted with one or more groups selected from halide and —OH.

Ra in embodiments comprises from about 1 to about 7 carbon atoms, for example from about 1 to about 5, or from about 1 to about 3 carbon atoms.

In formulae (2)-(7), where A is H, Ra can optionally be absent, such that it represents a chemical bond that directly links A and the corresponding moiety in Formula (2) to (7) to which Ra would otherwise be attached. In embodiments, the group Ra-A can be an Rb group.

Rb on each occurrence is independently selected from H and C1-4 alkyl groups, for example C1-2 alkyl groups, optionally with one or more substituents selected from halide and —OH groups. In embodiments, the C1-4 alkyl groups or C1-2 alkyl groups are unsubstituted. In Formulae (1) to (3), the group —C^{g}R₂^{b}— is typically —C^{g}H₂—.

In embodiments, Ra can be a saturated linear or branched aliphatic CᵥR₂ᵥ^{c} group or a cyclic C_{w}R_{2w-2}^{c} aliphatic group. v is an integer in the range of from about 1 to about 11, for example in the range of from about 1 to about 8, such as from about 1 to about 6 or from about 1 to about 4. w is an integer in the range of from about 3 to about 11, for example from about 4 to about 6

Rc on each occurrence is independently selected from H, —OH, halide, C1-4 alkyl, and C1-4 alkoxy, where the C1-4 alkyl and C1-4 alkoxy groups are optionally substituted with one or more groups selected from halide and —OH.

In formula (3), y is an integer in the range of from about 1 to about 4, and in embodiments all occurrences of Rb are H.

In embodiments, in formulae (4) to (7), Rb groups on Cn are H.

In embodiments, Ra can be an unsaturated linear or branched aliphatic CₓR_{2x-2y}^{c} group comprising “y” double bonds. x is an integer in the range of from about 2 to about 11, for example from about 2 to about 6 or from about 2 to about 4. y represents the number of double bonds, and is typically about 1 or about 2.

In further embodiments, Ra can be an unsaturated cyclic aliphatic C_{w}R_{2w-2y-2}^{c} group comprising “y” double bonds, where y is typically about 1 or about 2, and w is as defined above.

In still further embodiments, Ra can be a C_{z}R_{z-2}^{c} aromatic group. z is an integer selected from about 5 and about 6.

In still further embodiments, Ra can be a linear or branched aliphatic group comprising a cyclic aliphatic or aromatic ring. Thus, Ra can be a CₚR_{2p-2q}^{c}-E-CᵣR₂ᵣ₋₂ₛ^{c}, group having no more than about 11 carbon atoms, where E is C_{w}R_{2w-2}^{c}, C_{w}R_{2w-2y-2}^{c}, or C_{z}R_{z-2}^{c} as defined above. p and r are each independently a whole number from about 0 to about 8, where p+r is at least about 1. q and s are each the number of double bonds in the respective non-cyclic aliphatic component. In embodiments, each of q and s are independently selected from about 0, about 1 and about 2.

Halides are typically selected from F and Cl. In embodiments, however, the functional group is halide-free, such that there are no halides in groups A, Ra, Rb and Rc.

In embodiments, at least one Rc group is H. In other embodiments no more than two Rc groups are other than H, and in further embodiments, no more than one Rc group is other than H. In still further embodiments, all Rc groups are H.

In the above definitions of Ra, Rb and Rc, where there is more than one —OH substituent, there is typically no more than one —OH substituent per carbon atom.

In certain embodiments, Ra is an optionally substituted C1-C8 aliphatic (alkylene) group. In other embodiments, Ra is an optionally substituted C6 aromatic ring. In further embodiments, Ra is unsubstituted.

Substituted dialcohol cellulose materials can be made by known techniques. For example carboxylate-functionalised materials (e.g. those of formula (2) above) can be made using the method of Nishio et al; Cellulose, 2006 (13), 245-259 can be used, or the method described in DE102008024089. Other condensation reactions (e.g. to form those of Formula (1)) include acid-catalysed condensation with an alcohol or alkoxide. Materials with substituents of formula (3) can be made by alkali-catalysed reaction with a halocarboxylic acid (e.g. chloroacetic acid). For substituents of Formulae (4) to (7), the groups can be made by conventional reactions of un-reduced aldehyde groups formed when the cellulose ring is oxidised as set out above.

In embodiments, there are one or more substituents of formula (2), where the substituent is selected from acetate, propionate, butyrate, pentanoate, hexanoate, heptanoate, octanoate and phthalate. In further embodiments, it is selected from acetate, propionate and butyrate.

The degree of substitution (DS) of the hydroxyl groups of the cellulose by the one or more substituent groups can be in the range of from about 0 to about 3.2, for example in the range of from about 0 to about 3. In embodiments, the degree of substitution is zero, i.e. unsubstituted dialcohol cellulose is used.

The degree of polymerization (DP) of the (substituted) dialcohol cellulose can be determined by conventional methods, e.g. using the alkaline size exclusion chromatography (SEC) method described by Kasai et al in Cellulose, 2014, 21, 769-776. Typically, the DP value will be in the range of from about 100 to about 10 000, for example in the range of from about 200 to about 6 000.

The glass transition temperature (Tg) and the melting point of the (substituted) dialcohol cellulose can be modified or controlled by varying the functional groups on the dialcohol cellulose, by varying the molecular weight, or by varying the extent of oxidation or hydroxylation of the cellulose.

The spherical capsules are hollow, having a core-shell structure, in which the shell comprises the (substituted) dialcohol cellulose, and the hollow core contains a fluid, for example liquid or gaseous components deriving from the synthesis mixture. The core does not contain cellulose or cellulose-derivatives, e.g. crystalline cellulose phases, or any of the (substituted) dialcohol cellulose material that is present in the shell. Thus, the spherical capsule has non-uniform density, the density of the polymeric shell being higher than the density of the fluid-containing hollow core.

The (substituted) dialcohol celluloses used to prepare the capsules can have a density of about 1.2 to about 1.7 g cm-3, for example in the range of from about 1.35 to about 1.60 g cm-3.

In embodiments, the spherical capsules are expandable, and the capsule density can drop below about 1.00 g cm-3, for example in the range of from about 0.002 to about 0.80 g cm-3, or from about 0.005 to about 0.60 g cm-3. In further embodiments, the density of the expanded spherical capsules is in the range of from about 0.008 to about 0.40 g cm-3. Higher densities, particularly densities of about 1.00 g cm-3 or more, generally mean that the samples are not suitable for use in applications where sphere expansion is important. These are typically applications where the volume of material must be increased and/or where density reduction is required, e.g. when used in preparing lightweight foam-like materials.

When considering expandable characteristics of the spherical capsules, a number of factors can result in post-expanded densities being too high for effective utilisation. For example, high density can result from poor capsule yield, i.e. the percentage of spherical capsules is too low such that, after expansion, the extent of density reduction is insufficient. Another potential issue is poor expansion characteristics, which can arise where too many of the hollow capsules contain insufficient expansion agent or blowing agent to enable adequate expansion. This can result from the shell being too permeable to the expansion/blowing agent, or due to the shell being too thick or too inflexible to be able to expand. Another potential cause is aggregation or agglomeration of the capsules, which can negatively affect expansion performance.

In synthesising the spherical capsules, the (substituted) dialcohol cellulose is typically first dissolved or dispersed in a solvent, which is typically an organic solvent, although can be in the form of an ionic liquid or a cold aqueous alkali, for example aqueous alkali metal hydroxide where alkali metals are typically selected from Li, Na or K. The solvent is selected such that solubilisation of the (substituted) dialcohol cellulose is achieved. The solvent can be a solvent system comprising more than one component. For example, in embodiments, a solution of lithium chloride in dimethyl acrylamide can be used, as described by Berthold et al in J. Appl. Polymer Sci., 2004, 94(2), 424-431.

In embodiments, the solvent also comprises a non-polar organic compound. This can act as a cavity forming agent, to assist in forming the hollow core of the spherical capsule during the synthetic procedure. The non-polar organic compound is at least partially soluble in the solution which comprises the (substituted) dialcohol cellulose, e.g. a solubility of greater than about 1 wt % for example at least about 10 wt % at about 25° C. and atmospheric pressure (i.e. about 1.013 bara, where “bara” stands for bar-absolute). The non-polar organic compound is also insoluble, or only partially soluble in the antisolvent. For example, in embodiments, the solubility in the antisolvent is less than about 1 wt %, and in embodiments less than about 0.5 wt %, for example less than about 0.1 wt %.

The non-polar organic compound can be the same as so-called “blowing agents” often used in expanding foam or expandable microsphere applications. In this disclosure, the term “blowing agent” means the same as “non-polar organic compound”.

The non-polar organic compound typically has a boiling point above about 25° C. at about 5.0 bara pressure or above about 25° C. at about 3.0 bara pressure. Boiling points at elevated pressures can be calculated using the Clausius Clapeyron equation. Typically, the non-polar organic compound has a boiling point of greater than about −50° C. at atmospheric pressure.

Typically, they have a boiling point of about 250° C. or less at atmospheric pressure, for example about 150° C. or less, or about 50° C. or less. In embodiments, the boiling point at atmospheric pressure is less than about 0° C.

The blowing agent is preferably inert, and does not react with the cellulose-based shell.

Examples of blowing agents include dialkyl ethers, alkanes and halocarbons, e.g. chlorocarbons, fluorocarbons or chlorofluorocarbons. In embodiments, the dialkyl ether comprises two alkyl groups each selected from C2 to C5 alkyl groups. In embodiments, the alkane is a C3 to C12 alkane. In embodiments, the haloalkane is selected from C1 to C10 haloalkanes. The haloalkanes can comprise one or more halogen atoms selected from chlorine and fluorine. The alkyl or haloalkyl groups in the dialkyl ethers, alkanes and haloalkanes can be linear, branched or cyclic. One or a mixture of one or more blowing agents can be used.

In embodiments, for environmental reasons, the one or more blowing agents are selected from alkyl ethers and alkanes, and in further embodiments the one or more blowing agents are selected from alkanes. Haloalkanes are preferably avoided, due to their potential ozone depletion properties, and also their large global warming potentials.

Examples of suitable blowing agents that can be used include propane, n-pentane, isopentane, neopentane, cyclopentane, cyclohexane, n-butane, isobutane, isohexane, neohexane, heptane, isoheptane, octane, isooctane, isodecane, and isododecane. In embodiments, the blowing agent is selected from C3 to C8 linear or cyclic alkanes. In other embodiments, the blowing agent is selected from C4 to C12 iso-alkanes.

The blowing agent is typically selected so that it is insoluble in the water or aqueous phase of the synthesis mixture, but is at least partially soluble or miscible with the antisolvent.

The antisolvent is a liquid compound or a liquid mixture of compounds that causes precipitation of the (substituted) dialcohol cellulose. Thus, it can alternatively be termed a “precipitant” or “precipitating agent”. Liquid in this sense means liquid at standard temperature and pressure (about 25° C. and about 1.013 bara). The antisolvent is water-miscible. However, the (substituted) dialcohol cellulose is insoluble, or only partially soluble in the antisolvent. Partially soluble in this sense means that the (substituted) dialcohol cellulose has a solubility of no more than about 10 wt % in the antisolvent, for example a solubility of no more than about 5 wt %, or in embodiments no more than about 1 wt %.

The antisolvent is less polar than water, such that water on its own is not used as an antisolvent. The antisolvent in embodiments has a polarity of greater than that of methanol.

The polarity can be expressed in terms of dielectric constant, £, at about 20° C. Where there is more than one component of the antisolvent, the dielectric constant can be calculated from the dielectric constant of each of the individual components, suitably scaled based on their molar fractions in the mixture. This can be represented by Equation (1):

$${ɛ}_{a n t i} = {\sum }_{i = 1}^{n} {ɛ}_{i} {M}_{i} \qquad Equation ( 1 )$$

where:
εanti=the calculated dielectric constant of the antisolvent at about 20° C.;
εi=the dielectric constant of pure compound i at about 20° C.;
n=the number of different compounds in the antisolvent;
Mi=the mole fraction of compound i in the antisolvent.

Where n is about 1, then a single compound is used in the antisolvent, and εanti is the same as the dielectric constant of that single compound.

The above calculation may not truly represent the actual experimentally determined dielectric constant of the antisolvent mixture. However, it has been found that this definition (according to Equation 1) adequately describes which compounds or mixtures of compounds can be used as antisolvents.

The dielectric constant for water at about 20° C. is about 80.10. Therefore, the dielectric constant (εanti) of the antisolvent should be below about 80.10. In embodiments, the dielectric constant is in the range of from about 20.0 to below about 80.10, for example in the range of from about 20.0 to about 80.0. In embodiments, the dielectric constant is also above that of methanol, whose dielectric constant at about 20° C. is about 33.0. Thus, in embodiments the antisolvent has a dielectric constant (εanti) of greater than about 33.0, for example in the range of from greater than about 33.0 to less than about 80.1, or from about 34.0 to about 80.0, such as from about 38.0 to about 78.0, from about 45.0 to about 75.0, from about 55.0 to about 75.0, or from about 60.0 to about 70.0.

Another way of expressing polarity is by using relative polarity scales, which can be based on shifts in UV/Vis spectroscopic absorption bands of solvatochromic dyes in the presence of the respective solvent, compared to reference solvents. Such determinations are described, for example, by Reichardt in Chem. Rev., 1994, 94, 2319-2358. A dye that can be used is pyridinium N-phenolate betaine dye, and a relative polarity value, E_{T}^{N}, can be assigned to a solvent, where a value of about 1 corresponds to water, and about 0 (zero) corresponds to tetramethylsilane (as measured at about 25° C. and atmospheric pressure). Therefore, the E_{T}^{N} of the antisolvent should be less than about 1.00. Where the antisolvent comprises more than one component, then the averaged/scaled value can be calculated from Equation (2), which is similar to that set out above for the dielectric constant:

$${[ {E}_{T}^{N} ]}_{a n t i} = {\sum }_{i = 1}^{n} {[ {E}_{T}^{N} ]}_{i} {M}_{i} \qquad Equation ( 2 )$$

where:
[E_{T}^{N}]ₐₙₜᵢ=the calculated relative polarity of the antisolvent;
[E_{T}^{N}]ᵢ=the relative polarity of pure compound i, at about 25° C. and atmospheric pressure;
n=the number of different compounds in the antisolvent;
Mi=the mole fraction of compound i in the antisolvent.

A list of E_{T}^{N} values for many common solvents can be found in the above-mentioned Reichardt review. The [E_{T}^{N}]ₐₙₜᵢ value of the antisolvent should be below about 1.00. In embodiments, the value is in the range of from about 0.50 to about 0.97. In further embodiments, the value is above that of methanol, whose value is about 0.76. Thus, in embodiments the antisolvent has a value of greater than about 0.76, for example in the range of from greater than about 0.76 to less than about 1.00, for example in the range of from about 0.77 to about 0.97, such as from about 0.80 to about 0.95, from about 0.85 to about 0.94, or from about 0.90 to about 0.94.

The calculated values of component mixtures may not necessarily match experimentally determined values. However, it has been found that this definition (according to Equation 2) adequately describes which compounds or mixtures of compounds can be used as antisolvents.

Alcohols (including diols and triols) are conveniently used as an antisolvent, although typically as a mixture in a more polar solvent, for example water. Some examples of solvents that can be included in an antisolvent include C1-6 alcohols, C2-6 diols, C3-6 triols, C1-6 haloalcohols, C1-6 halodialcohols, C1-6 alcoholethers, C1-6 glycol ethers or glycerol ethers, C1-6 ketones and diketones, C1-6 aldehydes, C1-8 haloethers, C1-6 amines, C1-6 alcoholamines, C1-6 carboxylic acids and also their anhydrides and C1-4 esters, C1-6 nitriles, C1-6 amides and their C1-2 alkyl N- or N,N-substituted derivatives, C4-8 cyclic anhydrides or amides, C1-6 organosulfates and C1-6 sulfoxides. In embodiments, each component of the antisolvent has a dielectric constant of 20.0 or more. Specific examples include mixtures of one or more of the following in water; methanol, ethanol, 1-propanol, 2-propanol, 2-butanol, 2-chloroethanol, 3-chloro-1,2-propanediol, 1,3-butanediol, 1,4-butanediol, 1,5-pentanediol, acetaldehyde, acetone, bis(2-chloroethyl) ether, 2,4-pentanedione, t-butylamine, formic acid, acetic anhydride, acetonitrile, butanenitrile, formamide, N-methylformamide, N,N′-dimethyl acetamide, N,N-dimethylformamide, 2-pyrrolidone, dimethyl sulfate, epichlorohydrin, dimethylsulfoxide, ethylene glycol, ethylene glycol monomethyl ether, ethylene glycol monoethyl ether, ethylene glycol dimethyl ether, diethylene glycol, triethylene glycol, glycerol, ethanolamine, diethanolamine, and triethanolamine.

In embodiments, antisolvents do not comprise halogen-containing compounds or sulfoxide-containing compounds, due to their potentially negative environmental effects.

To prepare the spherical capsules, a solution comprising (substituted) dialcohol cellulose is prepared. The extent of oxidation of the dialcohol cellulose and/or the selection of substituent groups can be tailored to help ensure full miscibility with the solvent or solvent system. In embodiments, the solution also comprises the one or more non-polar organic compounds/blowing agents.

A suitable medium or solvent in which the (substituted) dialcohol cellulose is soluble is described by Berthold et al in J. Appl. Polymer Sci., 2004, 94(2), 424-431, which uses a solution of lithium chloride (LiCl) in dimethyl acetamide (DMAc). The concentration of the (substituted) dialcohol cellulose is typically in the range of from about 0.1 to about 10 wt %, for example in the range of from about 0.5 to about 5 wt %.

The solution comprising (substituted) dialcohol cellulose also comprises dissolved, non-polar organic compound (blowing agent). Typical concentrations will typically depend on the solubility of the non-polar organic compound in the solvent or solvent system, but are generally at least about 0.5 wt %, for example in the range of from about 0.5 to about 10 wt %.

The solution is combined with an antisolvent, such that the (substituted) dialcohol cellulose precipitates and forms spherical capsules with a hollow interior or core. The hollow core can contain one or more of the blowing agent, and may also contain quantities of the solvent and the antisolvent, depending on the porosity or permeability of the (substituted) dialcohol cellulose shell.

The synthesis can take place at temperatures in the range of from about 0 to about 100° C., although typically temperatures of about 0 to about 35° C. are preferred to ensure good solubility and retention of any volatile non-polar organic compounds.

Pressures in the range of from about 0.5 to about 10 bara can be used. Typically, the pressure is at least at least about 0.9 bara or at least atmospheric pressure, as reduced pressures can cause volatile non-polar organic solvents to evaporate, hence reducing their content in the solution comprising (substituted) dialcohol cellulose.

Addition can be carried out dropwise, which facilitates formation of spheres. Further, in embodiments, the (substituted) dialcohol cellulose-containing solution is added to the antisolvent. The size of the drops added can influence the size of spherical capsules formed.

Without being bound by theory, it is thought that the spherical capsules form as a result of localised formation of a separate phase of non-polar organic compound, due to its insolubility in the antisolvent. Thus, when the solution and antisolvent are mixed, precipitation of the (substituted) dialcohol cellulose occurs in a region where a separate non-polar organic phase exists. Since it cannot mix with the fluid phase, this separate non-polar organic phase migrates into the centre of the precipitation region, causing a shell of (substituted) dialcohol cellulose to form around it.

The capsules can be made in a range of sizes, for example having mean particle diameters in the range of from about 1 μm to about 5 mm About 0.5 to about 5.0 mm capsules can be made in one embodiment. In other embodiments, microspherical capsules can be made having diameters from about 1 to about 1000 μm. Microspheres as opposed to mm-sized spheres can be made using microfluidic procedures, for example as described by Utada et al in MRS Bulleting, 32, 2007, 702-708, and by Carrick et al in RCS Advances, 2014, 4, 19061-19067.

In embodiments, the spherical or microspherical capsules are expandable. Expanded capsules are typically in the range of from about 1.5 to about 8 times larger in diameter than unexpanded capsules, for example about 2 to about 7 times or about 3 to about 6 times their original diameter.

The particle sizes are suitably measured using light scattering techniques, e.g. laser diffraction, such as low angle laser light scattering (LALLS). Such techniques are particularly helpful for measuring microspheres. Other techniques include image analysis from a photograph or electronic micrograph image of the pre- or post-expanded spherical capsules.

To expand the capsules, they can be heated. The temperature required will be dependent on the boiling point of the blowing agent (non-polar organic compound) used. In embodiments, the temperature is above the boiling temperature of the blowing agent, while at the same time being below the melting temperature of the (substituted) dialcohol cellulose. Typical temperatures for expansion include ranges of about 0 to about 200° C., for example about 20 to about 200° C., such as about 50 to about 190° C. or about 100 to about 190° C.

In other embodiments, the pressure around the capsules is reduced. This can be achieved either by reducing the surrounding pressure by about 10% or more, for example about 20% or more or about 50% or more. Thus, for example, if the synthesis was carried out at ambient pressure, e.g. about 1 bara, then a pressure of about 0.9 bara or less, for example about 0.8 bara or less or about 0.5 bara or less can be used. This technique can cause evaporation or expansion of the blowing agent, which expands the capsules.

For expansion, the capsules should be in a softened state. This means either exceeding the glass transition temperature (Tg) of the (substituted) dialcohol cellulose, or by keeping the capsules in a wet state such that the wall is soft, e.g. by wetting them with anti-solvent or water under reduced pressure and/or at elevated temperature.

to a temperature in the range of from about 30° C. to about 200° C., for example in the range of from about 30 to about 150° C.

Ways of heating the spherical capsules include direct or indirect contact with a heat transfer medium such as steam or pressurised steam, as described for example in WO2004/056549, WO2014/198532 and WO2016/091847. In further embodiments, direct or indirect contact with other heated gases (e.g. air or nitrogen) optionally mixed with steam can be used. In still further embodiments, where indirect heating is used, a liquid heat transfer medium can be used, e.g. heated oil. In another embodiment, IR radiation can be used to heat the capsules.

Where the blowing agent is relatively involatile, then heating may not be necessary. For example, if the synthesis is conducted under elevated pressure, then it may simply be necessary to relieve the pressure to ensure expansion of the spherical capsules. Additionally, filtering the material from the liquid phase synthesis mixture can also result in expansion without any heating. Conversely, if the blowing agent is relatively involatile, then reduced pressures can be used. In general, pressures in the range of from about 0.5 to about 1.5 bara, and temperatures in the range of from about 10 to about 200° C. can be used, depending on the blowing agent, and the extent of molecular weight, ring opening and/or carboxylation or other functionalisation of the dialcohol cellulose.

Expansion properties of the capsules can be evaluated using a thermomechanical analyser (e.g. a Mettler TMA 841) and quantitative data can be obtained from images using suitable software, for example STARe software. Tstart is the temperature at which the expansion starts and Tmax is the temperature at which maximum expansion is obtained.

The capsules can be separated from the synthesis medium by known techniques, for example filtration, decantation or centrifugation.

They can be provided in the form of a slurry, for example in an aqueous slurry, or in the form of dried particles (e.g. dry powder). They can also be provided in wet-cake form, where the capsules are not completely dry, and remain loosely adhered to one another. The capsules can be provided in unexpanded or expanded form.

Applications of microspheres include the manufacture of paper (e.g. embossed paper, a paper filler, a sizing agent), inks, corks, cement based compositions, adhesives, foams, insulation materials, coatings, rubber-based products, thermoplastics, thermosets, ceramics, non-woven composite materials, fillers etc. to provide for example a lightweight filler in such applications.

Applications of mm-sized spheres include drug delivery, catalysis, insulating materials, packaging, cosmetics and optics.

### Examples

### [Dialcohol Cellulose Synthesis]

A dissolving-grade cellulose pulp was provided by Domsjö Fabriker AB, Sweden (Domsjö Dissolving Plus). The cellulose content was 93 wt %, with a surface charge of 29 μeq/g with a degree of polymerization of about 780. N, N-Dimethylacetamide (DMAc) and lithium chloride (LiCl) were purchase from Sigma Aldrich, and propane gas was purchased from AGA Gas AB.

The cellulose fibers were suspended in water at a concentration of 20 g/L and allowed to react with sodium periodate, NaIO4. The amount of sodium periodate used was sufficient to ensure a concentration of 1.35 g/g fibre. Also added was 2-propanol (6.3 vol %). The mixture was left for 2 hours in the dark at a temperature of 50° C. The reaction was stopped by filtration followed by washing with water until a filtrate conductivity of less than 5 μS/cm was achieved.

The resulting fibres at this stage had a carbonyl content of 2.62±0.03 mmol/g, corresponding to approximately 22% of the glucose rings being oxidised and hence ring-opened.

The fibres were then redispersed in water to a concentration of 8 g/L, and allowed to react with sodium borohydride, NaBH4, at a concentration of 0.5 g/g fibre. 0.01M Monosodium phosphate, NaH2PO4, was also added to ensure the pH was maintained below a value of 10. Reaction was continued for 2 h at room temperature, after which it was stopped by filtration, and the residue washed with water until the filtrate conductivity was below 5 μS/cm.

### [Capsule Synthesis]

Cellulose or dialcohol cellulose fibres were allowed to swell in water, and were rendered soluble using a solvent exchange procedure as described by Carrick et al. ACS Appl. Mater. Interfaces, 2014, 6(23), 20928-20935. In this method, the water-swollen fibers were suspended in 96% ethanol for 2 days, before being filtered. The ethanol-swollen fibers were suspended in DMAc, filtered and resuspended in DMAc a total of four times over a period of 2 days. The DMAc-swollen fibers were then dissolved by preparing a 7 wt % solution of LiCl/DMAc, by adding lithium chloride over a period of 30 minutes to DMAc that was heated in an oil bath to 110° C. for about 30 min, the LiCl being pre-heated in an oven at 105° C. to remove traces of water.

The solution was allowed to cool to 60° C., at which point the DMAc-treated cellulose fibers were added to the LiCl/DMAc solution to produce a 1.5 wt % cellulose solution. To facilitate dissolving of the pulp, the solution was stirred over night at room temperature.

Spherical capsules were formed using a solution solidification method described by Carrick et al. in Langmuir 2014, 30(26), 7635-7644. Firstly, 20 mL of the LiCl/DMAc/fibre solution prepared above was saturated with propane gas for 1 hour. Next, an antisolvent was added drop-wise using a needle with a diameter 1.2 mm, resulting in precipitation of mm-sized spherical capsules. The antisolvent used was selected from methanol, ethanol, isopropanol and aqueous mixtures of each of these. Water was also used as a control.

The capsules were washed by placing them in fresh non-solvent 24 h after the precipitation. The washing step was repeated 3 times a day for 2 days, using a shaking table and 250 mL of the non-solvent.

The dimensions of the produced capsules were measured from images captured with an optical microscope. The parameters were assessed on 10 capsules. The surface morphology and the capsules wall thickness were evaluated using a Hitachi S-4800 field emission scanning electron microscope (FE-SEM).

### [Expansion Experiments]

Capsule expansion was performed by exposing the capsules to a decreased external pressure. Some experiments were carried out in water, where the capsules were placed in a water-filled flask connected to a vacuum pump. In order to observe the expansion of the wet-state capsules taken out from water, they were placed in a glass pipette that was sealed at one end, and connected to a vacuum pump at the other end. Performance was assessed using a high-speed camera.

Properties of capsules made from dialcohol cellulose are shown in Table 1.

These results highlight that alcohols are suitable anti-solvents, although improved capsules are obtained when diluted in water, in particular having better gas encapsulation and retention properties. The best results appear to be associated with a polarity of above that of neat methanol, i.e. a relative polarity [E_{T}^{N}]ₐₙₜᵢ value of above 0.762 and εanti of above 33.7, but below that of water, i.e. below a relative polarity [E_{T}^{N}]ₐₙₜᵢ value of 1.000 and εanti of below 80.1.

TABLE 1
Dialcohol Cellulose Capsule Properties

| | | | | | Gas encap- |
|---|---|---|---|---|---|
| Example | Anti-solvent (a) | ϵanti | [E_{T}^{N}]ₐₙₜᵢ | Spherical? | sulation (b) |
| 1 (c) | water | 80.1 | 1.000 | No | no |
| 2 | water/methanol | 65.6 | 0.927 | Yes (d) | yes, high |
| | (1:1) | | | | |
| 3 | water/methanol | 63.7 | 0.917 | Yes | yes, high |
| | (1:1.2) | | | | |
| 4 | methanol | 33.0 | 0.762 | Yes | no |
| 5 | water/ethanol | 67.2 | 0.918 | Yes | yes, lower |
| | (1:1) | | | | |
| 6 | ethanol | 25.3 | 0.654 | Yes | no |
| 7 | water/isopropanol | 68.7 | 0.913 | Yes | yes, very |
| | (1:1) | | | | low |
| 8 | isopropanol | 20.2 | 0.546 | Yes | no |

(a) figures in parentheses represent volume ratios
(b) measured a few hours after preparation - relative efficiency of gas (propane) retention, based on visual inspection and the size of the hollow inner portion of the capsules
(c) comparative example
(d) tails present on the capsules

FIG. 1 shows photographs demonstrating the effects of different antisolvents, in which (a) relates to Example 4 (methanol only), (b) to Example 2 (1:1 water/methanol), (c) to Example 6 (ethanol only), (d) to Example 5 (1:1 water/ethanol) and (e) to Example 3 (1:1.2 water/methanol).

Mixtures of water/methanol as antisolvent, with εanti from about 60 to about 70 and [E_{T}^{N}]ₐₙₜᵢ from about 0.90 to 0.95, appeared to give optimum yield, size and homogeneity of the hollow spherical capsules.

Table 2 compares properties of capsules prepared from cellulose and also capsules of Example 3. The cellulose capsules were prepared using a route analogous to that of Example 3, except using cellulose fibres that had not undergone any oxidation/reduction pre-treatment.

TABLE 2
Comparison of Cellulose and Dialcohol Cellulose Capsules

| | Dialcohol | |
|---|---|---|
| | cellulose | |
| | (Example 3) | Cellulose |
| Solution concentration [wt %] | 1.5 | 1.5 |
| Kinematic viscosity of solution [mm2/s] | 24.54 | 2264.8 |
| Diameter of the wet capsule [mm] | 2.43 ± 0.09 | 2.21 ± 0.06 |
| Weight of the wet capsule [mg] | 4.62 ± 0.21 | 4.61 ± 0.31 |
| Diameter of the dry capsule [mm] | 1.29 ± 0.05 | n/a (a) |
| Weight of the dry capsule [mg] | 0.13 | 0.21 |
| Water percentage in the wet capsule [%] | 97.2 | 95.4 |
| Wet Capsule Density [kg m−3] | 614.93 | 815.69 |
| Dry Capsule Density [kg m−3] | 115.66 | n/a |

(a) The capsules were significantly deformed, such that their diameter could not be accurately measured.

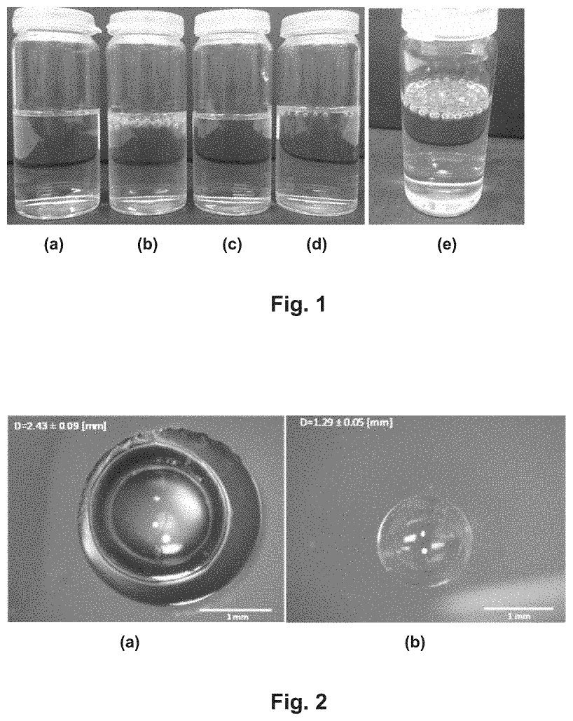

FIG. 2 shows optical microscope images of (a) wet and (b) air-dried dialcohol cellulose capsules of Example 3. The wet sample shows a thicker wall than the dry sample. However, a clear core/shell structure is evident.

FIG. 3 shows electron micrographs of capsules of Example 3, which have been (a) freeze-dried, and (b) air-dried, with micrographs (c) and (d) being respective cross sections. Micrographs (e) and (f) are magnified images of the highlighted sections of images (c) and (d) respectively. These micrographs highlight the wall thickness differences between wet and dried samples (the freeze-dried sample was carried out before drying, to preserve the wet characteristics of the capsules). In all cases, a core/shell structure is clearly evident.

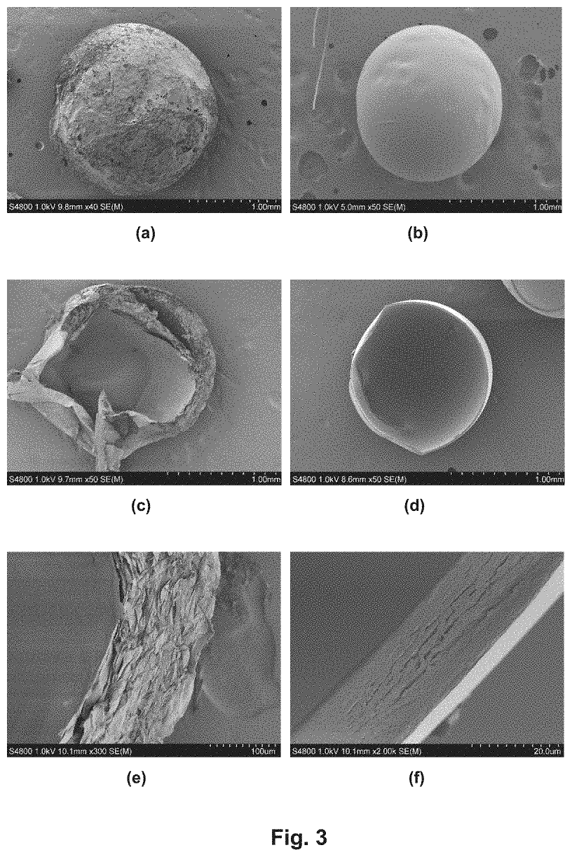

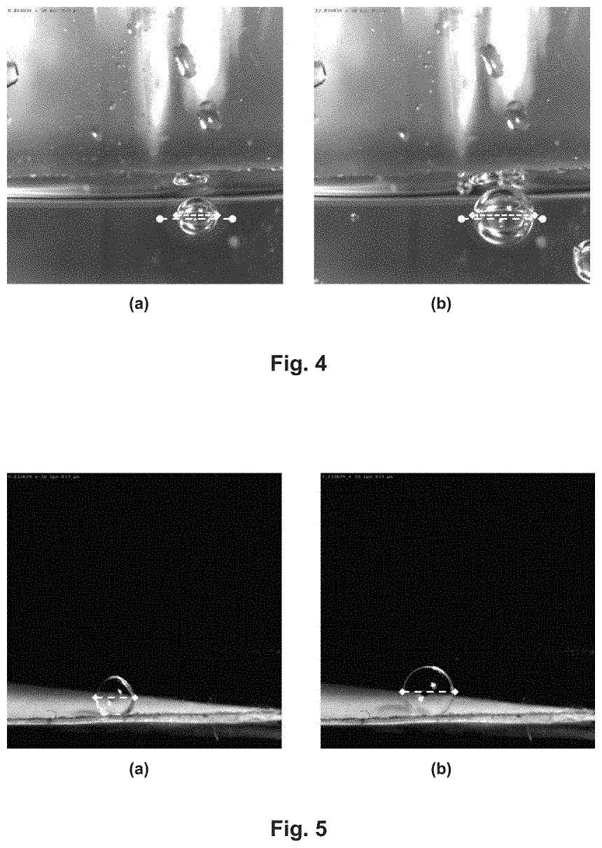

FIG. 4 shows expansion characteristics of the capsules of Example 3, where (a) is before and (b) is after applying a reduced pressure to a flask containing the spheres suspended in water, as described above.

The change in inner diameter from (a) to (b) is a factor of 1.49 (i.e. inner diameter (b)=1.49× inner diameter (a)), i.e. an increase of 49%. The change in outer diameter is a factor of 1.13 from (a) to (b), i.e. an increase of 13%.

FIG. 5 shows expansion characteristics of wet (but no longer water-suspended) capsules of Example 3 twenty minutes after their removal from the suspending liquid water, (a) before and (b) after being subjected to reduced pressure in a Pasteur pipette, as described above.

Note that, because the spheres are no longer in a water suspension (c.f. FIG. 4), then the polymeric shells are not swelled to the same extent, hence the polymeric shells appear thinner than those in FIG. 4.

The radius of the hollow sphere increased by a factor of 1.33 (i.e. a radius increase of 33%).

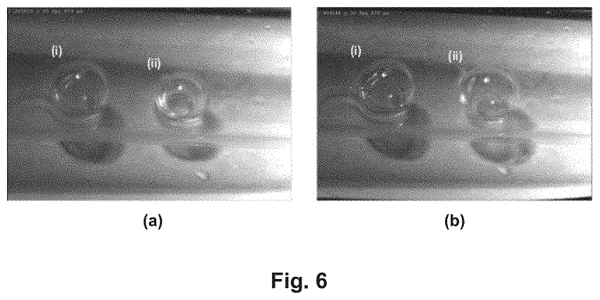

FIG. 6 shows (a) pre- and (b) post-expanded spherical capsules made of (i) cellulose and (ii) dialcohol cellulose.

The dialcohol cellulose hollow spheres expanded to a greater extent, the (outer) radius increasing by a factor of 1.24 (i.e. increase of 24%) compared to a factor of 1.05 (i.e. a 5% increase) for the cellulose capsules.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the various embodiments in any way. Rather, the foregoing detailed description will provide those skilled in the art with a convenient road map for implementing an exemplary embodiment as contemplated herein. It being understood that various changes may be made in the function and arrangement of elements described in an exemplary embodiment without departing from the scope of the various embodiments as set forth in the appended claims.

What is claimed is:

1. Spherical capsules comprising a polymeric shell surrounding a hollow core, in which the polymeric shell comprises a dialcohol cellulose that is optionally substituted.

2. Spherical capsules as claimed in claim 1, in which the polymeric shell comprises either;
(i) unsubstituted dialcohol cellulose; or
(ii) dialcohol cellulose substituted with one or more substituents according to the following formulae (1) to (7); 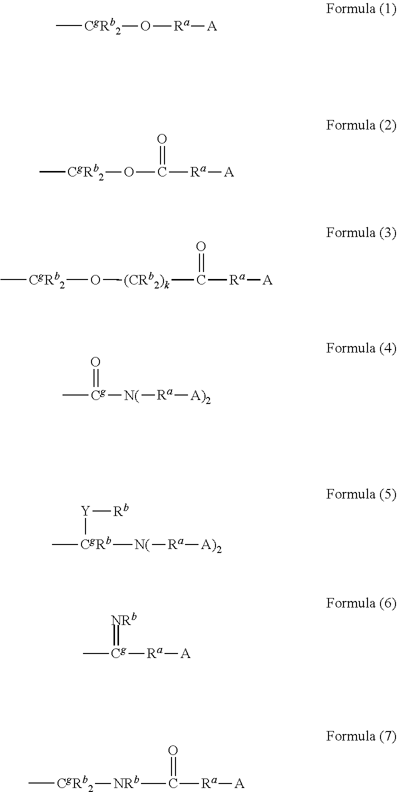
Where:
C^{g} is a carbon atom that is part of the dialcohol cellulose backbone;
A is selected from —H, —OR^{b}, and —C(O)OR^{b};
R^{a} is selected from;
(a) saturated or unsaturated aliphatic groups having from about 1 to about 11 carbon atoms, and which is linear, branched or cyclic; which are optionally substituted by one or more substituents selected from —OH, halide, C₁₋₄ alkyl, and C₁₋₄ alkoxy, and wherein the C₁₋₄ alkyl and C₁₋₄ alkoxy groups are optionally substituted with one or more groups selected from halide and —OH;
(b) about 5- and about 6-membered aromatic rings, which are optionally substituted as set out in (a);
(c) a saturated linear or branched aliphatic CᵥR₂ᵥ^{c}, group or a cyclic C_{w}R_{2w-2}^{c} aliphatic group, where v is an integer of from about 1 to about 11, where w is an integer of from about 3 to about 11, and where R^{c} is independently selected from H, —OH, halide, C₁₋₄ alkyl, and C₁₋₄ alkoxy, where the C₁₋₄ alkyl and C₁₋₄ alkoxy groups are optionally substituted as set out in (a);
(d) unsaturated linear or branched aliphatic CₓR_{2x-2y}^{c} groups comprising “y” double bonds, where x is an integer of from about 2 to about 11 and y is about 1 or about 2;
(e) unsaturated cyclic aliphatic C_{w}R_{2w-2y-2}^{c} groups comprising “y” double bonds, where y is about 1 or about 2, and where w is as defined above;
(f) C_{z}R_{z-2}^{c} aromatic groups, where z is about 5 or about 6;
(g) linear or branched aliphatic groups comprising a cyclic aliphatic or aromatic ring of formula CₚR_{2p-2q}^{c}-E-CᵣR₂ᵣ₋₂ₛ^{c}, having no more than about 11 carbon atoms, where E is C_{w}R_{2w-2}^{c}, C_{w}R_{2w-2y-2}^{c}, or C_{z}R_{z-2}^{c} as defined above, p and r are each independently a whole number from about 0 to about 8 and p+r is at least about 1, and where q and s are each the number of double bonds in the respective non-cyclic aliphatic component and are each independently selected from about 0, about 1 and about 2;
(h) where A is H in Formulae (2) to (7), R^{a} can be absent;
R^{b} on each occurrence is independently selected from H and C₁₋₄ alkyl groups, optionally with one or more substituents selected from halide and —OH groups;
in formula (3), k is an integer of from about 1 to about 4; and
in Formula (5), Y is O or is absent.

3. Spherical capsules as claimed in claim 1, which are expandable by heating and/or by reducing the external pressure.

4. A process for preparing spherical capsules as claimed in claim 1, comprising mixing a solution comprising dissolved dialcohol cellulose that is optionally substituted and one or more non-polar organic compounds with an antisolvent to form the spherical capsules, wherein the antisolvent comprises one or more compounds, and has one or more of the following features:
(i) the antisolvent has a calculated dielectric constant, εₐₙₜᵢ of less than about 80.1, where εₐₙₜᵢ is calculated according to the equation:
$${ɛ}_{anti} = {\sum }_{i = 1}^{n} {ɛ}_{i} {M}_{i}$$
where:
εₐₙₜᵢ=the calculated dielectric constant of the antisolvent at about 20° C.;
εᵢ=the dielectric constant of pure compound i at about 20° C.;
n=the number of different compounds in the antisolvent;
Mᵢ=the mole fraction of compound i in the antisolvent;
(ii) the antisolvent has a calculated relative polarity, [E_{T}^{N}]ₐₙₜᵢ of less than about 1.00, calculated according to the equation:
$${[ {E}_{T}^{N} ]}_{a n t i} = {\sum }_{i = 1}^{n} {[ {E}_{T}^{N} ]}_{i} {M}_{i}$$
where:
[E_{T}^{N}]ₐₙₜᵢ=the calculated relative polarity of the antisolvent;
[E_{T}^{N}]ᵢ=the relative polarity of pure compound i at about 25° C. and atmospheric pressure, compared to water;
n=the number of different compounds in the antisolvent;
M_{I}=the mole fraction of compound i in the antisolvent;
(iii) the antisolvent comprises one or more compounds selected from C₁₋₆ alcohols, C₂₋₆ diols, C₃₋₆ triols, C₁₋₆ haloalcohols, C₁₋₆ halodialcohols, C₁₋₆ alcoholethers, C₁₋₆ glycol ethers or glycerol ethers, C₁₋₆ ketones and diketones, C₁₋₆ aldehydes, C₁₋₈ haloethers, C₁₋₆ amines, C₁₋₆ alcoholamines, C₁₋₆ carboxylic acids and also their anhydrides and C₁₋₄ esters, C₁₋₆ nitriles, C₁₋₆ amides and their C₁₋₂ alkyl N- or N,N-substituted derivatives, C₄₋₈ cyclic anhydrides or amides, C₁₋₆ organosulfates and C₁₋₆ sulfoxides, and optionally also comprises water; and
(iv) the solubility of the non-polar organic compound in the antisolvent is less than about 1 wt %.

5. A process as claimed in claim 4, in which one or more of the following conditions apply:
(i) the non-polar organic compound is selected from C₃₋₈ alkanes and C₄₋₁₂ isoalkanes;
(ii) the polymeric shell of the spherical capsules comprises either
unsubstituted dialcohol cellulose; or
dialcohol cellulose substituted with one or more substituents according to the following formulae (1) to (7); 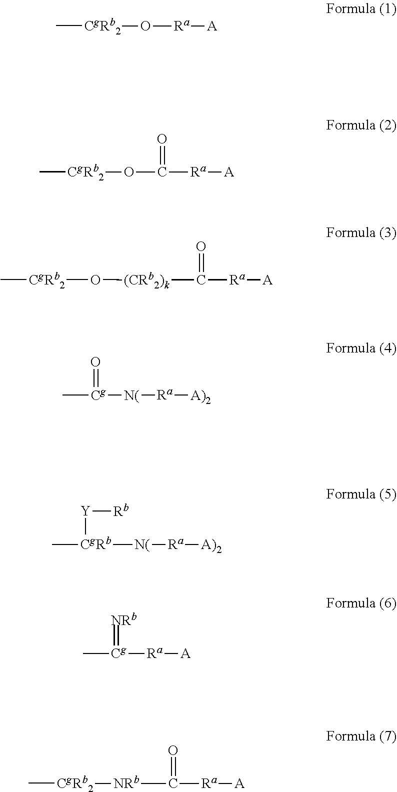
Where:
C^{g} is a carbon atom that is part of the dialcohol cellulose backbone;
A is selected from —H, —OR^{b}, and —C(O)OR^{b};
R^{a} is selected from;
saturated or unsaturated aliphatic groups having from about 1 to about 11 carbon atoms, and which can be linear, branched or cyclic; which are optionally substituted by one or more substituents selected from —OH, halide, C₁₋₄ alkyl, and C₁₋₄ alkoxy, and wherein the C₁₋₄ alkyl and C₁₋₄ alkoxy groups are optionally substituted with one or more groups selected from halide and —OH;
about 5- and about 6-membered aromatic rings, which are optionally substituted as set out in (a);
a saturated linear or branched aliphatic CᵥR₂ᵥ^{c} group or a cyclic C_{w}R_{2w-2}^{c} aliphatic group, where v is an integer of from about 1 to about 11, where w is an integer of from about 3 to about 11, and where R^{c} is independently selected from H, —OH, halide, C₁₋₄ alkyl, and C₁₋₄ alkoxy, where the C₁₋₄ alkyl and C₁₋₄ alkoxy groups are optionally substituted as set out in (a);
unsaturated linear or branched aliphatic CₓR_{2x-2y}^{c} groups comprising “y” double bonds, where x is an integer of from about 2 to about 11 and y is about 1 or about 2;
unsaturated cyclic aliphatic C_{w}R_{2w-2y-2}^{c} groups comprising “y” double bonds, where y is about 1 or about 2, and where w is as defined above;
C_{z}R_{z-2}^{c} aromatic groups, where z is about 5 or about 6;
linear or branched aliphatic groups comprising a cyclic aliphatic or aromatic ring of formula CₚR_{2p-2q}^{c}-E-CᵣR₂ᵣ₋₂ₛ^{c}, having no more than about 11 carbon atoms, where E is C_{w}R_{2w-2}^{c}, C_{w}R_{2w-2y-2}^{c}, or C_{z}R_{z-2}^{c} as defined above, p and r are each independently a whole number from about 0 to about 8 and p+r is at least about 1, and where q and s are each the number of double bonds in the respective non-cyclic aliphatic component and are each independently selected from about 0, about 1 and about 2;
where A is H in Formulae (2) to (7), R^{a} can be absent;
R^{b} on each occurrence is independently selected from H and C₁₋₄ alkyl groups, optionally with one or more substituents selected from halide and —OH groups;
in formula (3), k is an integer of from about 1 to about 4; and
in Formula (5), Y is O or is absent; or
(iii) the εₐₙₜᵢ value of the antisolvent is of from about 20.0 to about 80.0, or from about 34.0 to about 80.0.

6. A process as claimed in claim 4, in which the solution comprising the dialcohol cellulose that is optionally substituted is added to the antisolvent.

7. A process as claimed in claim 4, in which the spherical capsules are expandable.

8. A process as claimed in claim 7, in which the spherical capsules are expanded by heating to above the glass transition temperature and below the melting temperature of the dialcohol cellulose that is optionally substituted; and/or by reducing the external pressure by 10% or more.

9. Spherical capsules as claimed in claim 1, in which the polymeric shell comprises unsubstituted dialcohol cellulose.

10. Spherical capsules as claimed in claim 2, in which the polymeric shell comprises dialcohol cellulose substituted with one or more substituents according to Formula (1).

11. Spherical capsules as claimed in claim 2, in which the polymeric shell comprises dialcohol cellulose substituted with one or more substituents according to Formula (2).

12. Spherical capsules as claimed in claim 2, in which the polymeric shell comprises dialcohol cellulose substituted with one or more substituents according to Formula (3).

13. Spherical capsules as claimed in claim 2, in which the polymeric shell comprises dialcohol cellulose substituted with one or more substituents according to Formula (4).

14. Spherical capsules as claimed in claim 2, in which the polymeric shell comprises dialcohol cellulose substituted with one or more substituents according to Formula (5).

15. Spherical capsules as claimed in claim 2, in which the polymeric shell comprises dialcohol cellulose substituted with one or more substituents according to Formula (6).

16. Spherical capsules as claimed in claim 2, in which the polymeric shell comprises dialcohol cellulose substituted with one or more substituents according to Formula (7).
